(19) United States
(12) Patent Application Publication
(10) Pub. No.: US 2026/0040047 A1
(43) Pub. Date: Feb. 5, 2026

(54) METHOD AND SYSTEM FOR SHARING DATA AMONGST HANDHELD INTERACTION DEVICES

(71) Applicant: Ai2Ai Oy, Turku (FI)

(72) Inventors: Henrik Terävä, Turku (FI); Anton Ramsay, Turku (FI)

(73) Assignee: Ai2Ai Oy, Turku (FI)

(21) Appl. No.: 19/100,026

(22) PCT Filed: Jul. 4, 2023
(86) PCT No.: PCT/FI2023/050425

§ 371 Date: Jan. 30, 2025

(30) Foreign Application Priority Data
Aug. 1, 2022 (FI) 20225696

(51) Int. Cl. H04W 4/80; G06F 3/01

(52) U.S. Cl. CPC H04W 4/80; G06F 3/017

(57) ABSTRACT

A method for sharing data amongst handheld interaction devices including: detecting first gesture input provided using first handheld interaction device; mapping first gesture input to first gesture code; sharing first gesture code(s) to second handheld interaction device(s); detecting second gesture input(s) provided using second handheld interaction device(s); mapping second gesture input(s) to second gesture code(s); comparing first gesture code with second gesture code(s) for determining whether second gesture code amongst second gesture code(s) is equal to first gesture code; when second gesture code is equal to first gesture code, activating corresponding second handheld interaction device for receiving first data; and sending first data from first handheld interaction device to corresponding second handheld interaction device.

### TECHNICAL FIELD

The present disclosure relates to methods for sharing data amongst handheld interaction devices. Moreover, the present disclosure also relates to systems for sharing data amongst handheld interaction devices. Further, the present disclosure also relates to handheld interaction devices.

### BACKGROUND

With advent in technology, communication systems which facilitate data sharing and communication between different devices have gradually improved. In this present day, users can share vast amount of data with each other. This data may be temporary or permanent in nature. For example, stories on many social media applications are temporarily available for a predefined period of time or for a predefined number of views, which is generally stored only temporarily in a given device. Moreover, permanent data shared between devices is stored in the memory of the device unless otherwise removed by the user.

However, such communication systems are limited with respect to authorization, even when the users are in a same physical space. Users have to provide linking authorizations for each device in order for the devices to link to each other and share data. For example, if two devices wish to share data using Bluetooth, they are required to have a same access code in order to authorize such sharing of data. This would generally require multiple pin codes and approval clicks before the two devices are linked. This is time-taking and excessive and causes the users to either pause their time together or procrastinate on sharing the data.

Such excessive authorizations also deprive the users of seamless experiences which could be otherwise encountered. Moreover, once the data is shared, it is individually retained in memories of user devices, which unnecessarily utilize memory space and gradually reduce performance of the user devices. Such data is often unused and keeps accumulating in the memories, i.e., is not deleted or cleaned automatically.

Therefore, in light of the foregoing discussion, there exists a need to overcome the aforementioned drawbacks associated with quick and easy sharing of data between devices without requiring excessive authorisations.

### SUMMARY

The present disclosure seeks to provide a method for sharing data amongst handheld interaction devices. The present disclosure also seeks to provide a system for sharing data amongst handheld interaction devices. The present disclosure also seeks to provide a handheld interaction device. An aim of the present disclosure is to provide a solution that overcomes at least partially the problems encountered in prior art.

In one aspect, an embodiment of the present disclosure provides a method for sharing data amongst handheld interaction devices that are communicably coupled, the method comprising:
detecting a first gesture input that is provided using a first handheld interaction device, wherein the first gesture input is an activity related to sharing a first data from the first handheld interaction device to at least one second handheld interaction device;
mapping the first gesture input to a first gesture code from amongst a first set of gesture codes that are stored in the first handheld interaction device;
sharing at least the first gesture code to the at least one second handheld interaction device;
detecting at least one second gesture input that is provided using the at least one second handheld interaction device;
mapping the at least one second gesture input to at least one second gesture code from amongst at least one second set of gesture codes that are stored in the at least one second handheld interaction device;
comparing the first gesture code with the at least one second gesture code for determining whether a second gesture code amongst the at least one second gesture code is equal to the first gesture code;
when the second gesture code is equal to the first gesture code, activating a corresponding second handheld interaction device amongst the at least one second handheld interaction device for receiving the first data; and
sending the first data from the first handheld interaction device to the corresponding second handheld interaction device.

In another aspect, an embodiment of the present disclosure provides a system for sharing data amongst handheld interaction devices that are communicably coupled, the system comprising:

a first processor of a first handheld interaction device; and
at least one second processor of at least one second handheld interaction device;
wherein the first processor is configured to:
detect a first gesture input that is provided using the first handheld interaction device, wherein the first gesture input is an activity related to sharing a first data from the first handheld interaction device to the at least one second handheld interaction device;
map the first gesture input to a first gesture code from amongst a first set of gesture codes that are stored in the first handheld interaction device; and
share at least the first gesture code to the at least one second handheld interaction device;
   and wherein the at least one second processor is configured to:
detect at least one second gesture input that is provided using the at least one second handheld interaction device;
map the at least one second gesture input to at least one second gesture code from amongst the at least one second set of gesture codes that are stored in the at least one second handheld interaction device;
compare the first gesture code with the at least one second gesture code to determine whether a second gesture code amongst the at least one second gesture code is equal to the first gesture code;
when the second gesture code is equal to the first gesture code, activate a corresponding second handheld interaction device amongst the at least one second handheld interaction device for receiving the first data; and
receive the first data from the first handheld interaction device, the first data being sent by the first processor upon receiving the first command at the first handheld interaction device.

In yet another aspect, an embodiment of the present disclosure provides a handheld interaction device comprising:
a housing which provides shape and structure to said handheld interaction device;
a battery configured to power the handheld interaction device;
a communication interface;
at least one sensor;
at least one memory configured to store a data, a set of gesture inputs, a set of gesture codes, and information indicative of a linking of each gesture input in the set of gesture inputs to a corresponding gesture code in the set of gesture codes; and
a processor coupled to the communication interface, the at least one sensor, and the at least one memory, wherein the processor is configured to execute a set of steps of the method for sharing data amongst handheld interaction devices.

Embodiments of the present disclosure substantially eliminate or at least partially address the aforementioned problems in the prior art, and enable automatic activation and usability of handheld interaction devices for any alignment of such devices.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B illustrate steps of a method for sharing data amongst first and second handheld interaction device, in accordance with an embodiment of the present disclosure;

FIG. 2 illustrates steps of a method for sharing data amongst second and third handheld interaction device, in accordance with an embodiment of the present disclosure;

FIG. 3 illustrates steps of a method for sharing data amongst handheld interaction devices, in accordance with an embodiment of the present disclosure;

FIGS. 4A, 4B, 4C and 4D illustrate an exemplary set of gestures and corresponding gesture codes, in accordance with an embodiment of the present disclosure;

FIGS. 5A and 5B illustrate a system for sharing data amongst handheld interaction devices, in accordance with an embodiment of the present disclosure;

FIG. 6A, 6B, 6C and 6D illustrate an environment wherein a system and a method for sharing data amongst handheld interaction devices are being utilized, in accordance with an embodiment of the present disclosure;

FIG. 7 illustrates a handheld interaction device, in accordance with an embodiment of the present disclosure;

FIGS. 8A, 8B, 8C, 8D and 8E illustrate a handheld interaction device, in accordance with various embodiments of the present disclosure; and

FIG. 9 illustrates an exemplary process flow of a method for sharing data amongst handheld interaction devices using auxiliary data, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for sharing data amongst handheld interaction devices that are communicably coupled, the method comprising:
detecting a first gesture input that is provided using a first handheld interaction device, wherein the first gesture input is an activity related to sharing a first data from the first handheld interaction device to at least one second handheld interaction device;
mapping the first gesture input to a first gesture code from amongst a first set of gesture codes that are stored in the first handheld interaction device;
sharing at least the first gesture code to the at least one second handheld interaction device;
detecting at least one second gesture input that is provided using the at least one second handheld interaction device;
mapping the at least one second gesture input to at least one second gesture code from amongst at least one second set of gesture codes that are stored in the at least one second handheld interaction device;
comparing the first gesture code with the at least one second gesture code for determining whether a second gesture code amongst the at least one second gesture code is equal to the first gesture code;
when the second gesture code is equal to the first gesture code, activating a corresponding second handheld interaction device amongst the at least one second handheld interaction device for receiving the first data; and
sending the first data from the first handheld interaction device to the corresponding second handheld interaction device.

In another aspect, an embodiment of the present disclosure provides a system for sharing data amongst handheld interaction devices that are communicably coupled, the system comprising:

a first processor of a first handheld interaction device; and at least one second processor of at least one second handheld interaction device;
wherein the first processor is configured to:
detect a first gesture input that is provided using the first handheld interaction device, wherein the first gesture input is an activity related to sharing a first data from the first handheld interaction device to the at least one second handheld interaction device;
map the first gesture input to a first gesture code from amongst a first set of gesture codes that are stored in the first handheld interaction device; and
share at least the first gesture code to the at least one second handheld interaction device;
   and wherein the at least one second processor is configured to:
detect at least one second gesture input that is provided using the at least one second handheld interaction device;
map the at least one second gesture input to at least one second gesture code from amongst the at least one second set of gesture codes that are stored in the at least one second handheld interaction device;
compare the first gesture code with the at least one second gesture code to determine whether a second gesture code amongst the at least one second gesture code is equal to the first gesture code;
when the second gesture code is equal to the first gesture code, activate a corresponding second handheld interaction device amongst the at least one second handheld interaction device for receiving the first data; and
receive the first data from the first handheld interaction device, the first data being sent by the first processor upon receiving the first command at the first handheld interaction device.

In yet another aspect, an embodiment of the present disclosure provides a handheld interaction device comprising:
a housing which provides shape and structure to said handheld interaction device;
a battery configured to power the handheld interaction device;
a communication interface;
at least one sensor;
at least one memory configured to store a data, a set of gesture inputs, a set of gesture codes, and information indicative of a linking of each gesture input in the set of gesture inputs to a corresponding gesture code in the set of gesture codes; and
a processor coupled to the communication interface, the at least one sensor, and the at least one memory, wherein the processor is configured to execute a set of steps of the method for sharing data amongst handheld interaction devices.

The present disclosure provides the aforementioned method and system for sharing data amongst handheld interaction devices. The present disclosure also provides the aforementioned handheld interaction device. Herein, the first data is shared between the handheld interaction devices using gestures. The first handheld interaction device provides the first gesture input, which is correspondingly mapped to the first gesture code. This first gesture code is shared with the at least one second handheld device, which thereafter provides the at least one second gesture input correspondingly mapped to the at least one second gesture code. The first gesture code and the at least one second gesture code are compared, and when they are equal to each other, the first data is shared. Such sharing of data using gestures is advantageous because it allows easier sharing of data between devices present in a same physical space. This is useful for improving user experience in everyday life, and even in extreme and emergency situations where immediate sharing of data is essential. Such sharing of data considerably reduces the time and effort required by the user as the user is not required to provide excessive authorizations and follow linking procedure for sharing the data, and thus ensures ease of usability.

The method for sharing data amongst handheld interaction devices enables the handheld interaction devices to share data in an easy and time-efficient manner. Throughout the present disclosure, the term “handheld interaction device” refers to a device which facilitates human interaction. Throughout the description, the generic terminology “handheld interaction device” encompasses at least one of: the first handheld interaction device, the at least one second handheld interaction device, the at least one third handheld interaction device. The handheld interaction device is hand-held only during use. In an example, if a user holds the handheld interaction device to use the same, it will be considered hand-held. In another example, the handheld interaction device may be hand-held but still may not be in use. The hand-held interaction device may not be hand-held when it is not in use. For example, when the handheld interaction device is kept on a surface, it may not be in use. Herein, handheld interaction devices may be communicably coupled prior to an interaction, or they may be coupled in a manner specified in the present disclosure. Optionally, the handheld interaction devices are communicably coupled using a wireless network. Examples of the wireless network includes, but is not limited to, a wireless local area network (WLAN), a Bluetooth® network, a wireless fidelity network, a near-field communication network. Optionally, a given handheld interaction device further comprises at least one light sensor, wherein the at least one light sensor collects light information indicative of an amount of light available in a real-world environment.

Throughout the present disclosure, the term “gesture input” refers to an input provided via a given handheld interaction device. The gesture input is implemented as at least the first gesture input, and additionally optionally, as the at least one second gesture input, and yet additionally optionally as at least one third gesture input. Optionally, the gesture input may be provided via hand movements of a user in air. Examples of gesture inputs include, but are not limited to, a straight line, a square, a triangle, a circle, a semicircle, an ellipse, a pentagon. Alternatively, optionally, the gesture input is provided by at least one of: squeezing (i.e., by applying compressive force) the given handheld interaction device, pressing a button of the given handheld interaction device, drawing a gesture on a touch screen of the given handheld interaction device, selecting an option on a touch screen of the given handheld interaction device. Herein, an amount of the compressive force applied to the handheld interaction device further has another corresponding meaning and another corresponding result. For example, when the gesture input is drawing a circular shape in the air while squeezing the handheld interaction device, squeezing said handheld interaction device gently or hardly may have another corresponding meanings, respectively, which are different from each other. Yet alternatively, optionally, the gesture input is provided by the at least one of: squeezing the given handheld interaction device, pressing the button of the given handheld interaction device, in at least one section of the gesture input, at a time of providing the gesture input by the hand movements of the user in the air. Beneficially, providing the gesture input in such a manner ensures that said gesture input is not duplicated by just seeing said gesture input. In a first example, a user drawing a square holding the handheld interaction device may be detected as the gesture input. Herein, when drawing, the user may squeeze the handheld interaction device at different sections of the square.

Optionally, a step of detecting a gesture input comprises processing sensor data generated by at least one sensor of a handheld interaction device using which the gesture input is provided, the at least one sensor being at least one of: an accelerometer, a gyroscope, a magnetometer. Beneficially, the at least one sensor senses a gesture input being provided via the handheld interaction device. Optionally, a gesture input is provided by a user using a handheld interaction device by moving the handheld interaction device in air whilst doing at least one of: pressing a button of the handheld interaction device, squeezing the handheld interaction device, holding the handheld interaction device. For example, the gesture input may be provided by drawing a circle in air using the handheld interaction device.

Optionally, the first data comprises at least one of: software application data, user data, text data, audio data, image data, video data, information of the first data, information of second data that is stored in an external device, metadata associated with the first data, a high-level program code. The first data is composed in such a manner that said first data can be transferred in a short time wirelessly or in a wired manner. This enables sharing the first data from the first handheld interaction device to at least one second handheld interaction device in real time or near-real time, instead of having to download an entire program and/or updating the first data of the first handheld interaction device or the at least one second handheld device.

The metadata associated with the first data may, for example, be gesture data (for example, values in the sensor data captured by the at least one sensor of the first handheld interaction device). Optionally, the first gesture input is provided by a first user associated with the first handheld interaction device. It will be appreciated that the first data is shared such that the users engage in collaborative activities for which the first data is needed.

Optionally, the method further comprises obtaining the first data at the first handheld interaction device from at least one data source, and storing the first data in at least one memory of the first handheld interaction device. The at least one data source is implemented as: an external data source that a first processor of the first handheld interaction device is communicably coupled with, the first processor of the first handheld interaction device, a local data source of the first processor, or similar. It will be appreciated that the first data is shared such that the second handheld device gains access to the first data as well. Such exchange of data facilitates interaction between users.

Optionally, a gesture input is detected based on at least one of: a number of points in the gesture input, a relative location of a starting point and an ending point of the gesture input, a pattern of direction changes in the gesture input, a number of direction changes in the gesture input, an angle between two consecutive direction changes in the gesture input, a total revolution about a given point, a length of movement along a direction in the gesture input. The “number of points in the gesture input” refers to requisite number of points that are required to provide the gesture input. A given gesture input at least comprises: a starting point, an ending point, and optionally, at least one intermediate point. For example, the number of points in a gesture input can be two in case of the gesture input being a straight line, four in case of the gesture input being a triangle, five in case of a quadrilateral, six in case of a pentagon, and similar. With reference to the first example, the user holding the handheld interaction device drawing the gesture input with five number of points may be detected as a square.

The term “relative location” of a starting point and an ending point refers to a difference (i.e., an offset) between a position of the starting point and a position of the ending point. The relative location may be expressed in at least one of: units of length, coordinates (for example, polar coordinates). For example, the relative location will be zero in case of making a closed shape for the gesture input, for example, the square, the triangle, the circle, the semicircle, the pentagon, and similar. With reference to the first example, the user drawing the square holding a handheld interaction device will have the relative location of the starting point and the ending point as zero, hence, this will be used to detect that the gesture input is the closed figure. The term “pattern of direction changes” refers to a form of a sequence of changes in the direction of movement of the handheld interaction device that is read as the gesture input. The pattern of direction changes may be a constantly changing direction in case the gesture input is a curve, for example, when the gesture input is the circle, the semicircle, and the ellipse. The term “number of direction changes” refers to a finite amount of changes in the direction of movement of the handheld interaction device to form a pattern that is read as the gesture input. The number of direction changes has the integral value. For example, the number of direction changes may be implemented as at least one of: two direction changes, three direction changes, four direction changes in case the gesture input is quadrilateral, five direction changes in case the gesture input is pentagonal. With reference to the first example, when the user holding a handheld interaction device will have four direction changes in the movement of the handheld interaction device, and the number of direction changes may be used to detect that the gesture input is square.

The term “angle between two consecutive direction changes in the gesture input” refers to angular changes in the direction of movement of the handheld interaction device to form a pattern that is read as the gesture input. The angle between two consecutive direction changes in the gesture input has units in either radians or degrees. For example, the angle between two consecutive direction changes may be 60 degrees in case the gesture input is an equilateral triangle and 108 degrees in case the gesture input is a pentagon. With reference to the first example, when the user holding a handheld interaction device will have the angle between two consecutive direction changes in the direction of movement of the handheld interaction device as 90 degrees, the angle of direction changes may be used to detect that the gesture input is square.

The term “total revolution about a given point” refers to revolutions made by the handheld interaction device to form the pattern that is read as the gesture input. The total revolution about the given point has the integral value. For example, the user may make five revolutions about a given point to form a helical curve that has five turns. With reference to the first example, when the user holding the handheld interaction device makes zero total revolution about the given point, this may be used to detect that the gesture input is a two-dimensional figure like the square. The term “length of movement” along the direction of movement in the gesture input refers to an extent of the gesture input along the direction of movement. For example, the length of movement may signify a radius of the gesture input that is circular, or the length of movement may signify a base and a height of the gesture input that is triangular and/or rectangular. With reference to the first example, when the user draws the square holding the handheld interaction device, the length of movement may be used to determine the size of the square. It will be appreciated, at least one of the above-mentioned parameters are chosen to detect the gesture input. Moreover, at least one of the above-mentioned parameters are chosen for identifying similarity or dissimilarity between two different gesture inputs for establishing communication of data between two different handheld interaction devices when the gesture input for the two different handheld interaction devices is same.

Optionally, a distance is related to at least one of: the size of a gesture input, a number of times the gesture input is provided in one instance. The distance is at least one of: the first distance, the second distance. The term “distance” refers to a length of space in a real-world environment over which the user wishes to communicate data using the handheld interaction device. In a first aspect, the distance is determined by the size of the gesture input. For example, a circular gesture input of radius one centimetre may indicate communication between two users at the distance of five metres and a circular gesture input of radius two centimetres may indicate communication between two users at a distance of ten metres. In another aspect, the distance is determined by the number of times the gesture input is provided in one instance. For example, a circular gesture input may indicate communication between two users at the distance of five metres and a circular gesture input given twice in an instance may indicate communication between two users at a distance of ten metres. In yet another aspect, the distance could be any one of: a predefined decision, a dynamic decision based on at least one rule or at least one situation. For example, the at least one rule may be difference in the distance based on the light information of the real-world environment.

It will be appreciated that the distance may be used to specify whether a data is to be communicated only within some distance. For example, some distance can be five metres. Any user at the distance greater than five metres will not receive the data.

Optionally, the at least one second handheld interaction device is within a predefined distance from the first handheld interaction device. The term “predefined distance” is defined as a maximum allowable distance between the first handheld interaction device and the at least one second handheld interaction device to enable efficient data communication therebetween. Optionally, the predefined distance lies in a range of 80-140 meters. Herein, such range for the predefined distance is applicable when the first handheld interaction device and the at least one second handheld interaction device are in a same physical environment. For example, the predefined distance may be from 80, 85, 90, 110, or 115 meters up to 100, 120, 130, 135 or 140 meters. In an example, the predefined distance may be 100 meters. Alternatively, optionally, when the first handheld interaction device and the at least one second handheld interaction device are connected via a mesh, the predefined distance is extendable to an infinite distance. The mesh refers to a network wherein multiple devices are interconnected with each other. In this scenario, the handheld interaction devices are communicably coupled using a wired network. Moreover, since the network is wired, there is no limit of a predefined distance since the wired network can be established all over planet earth. For example, if a plurality of handheld interaction devices are connected in a chain, they could be linked to an unlimited distance, making the predefined distance unlimited. Optionally, the at least one third handheld interaction device is within the predefined distance from the at least one second handheld interaction device. It will be appreciated that since the handheld interaction devices are mostly wirelessly connected and wirelessly interact with each other, the predefined distance ensures that a connection between two such handheld interaction devices is fast and reliable because wireless connections vary depending on distances.

Optionally, the predefined distance is related to at least one of: a size of a gesture input, a number of times the gesture input is provided in one instance. Herein, the size of the gesture input refers to a measure of an extent of the gesture input. Moreover, the size may define how big or small the gesture input is, and the predefined distance between two given handheld interaction devices may vary based on the size of the gesture input. Furthermore, the size of the gesture input also corresponds to a particular meaning or a particular event. In an instance, when the predefined distance is related to the size of the gesture input, the gesture input may need to cover a particular physical distance or a particular physical span, to be considered valid. In another instance, when the predefined distance is related to the number of times the gesture input is provided, the gesture input may need to be repeated a particular number of times at the predefined distance to be considered valid. For example, a big gesture input may relate to a long predefined distance, whereas a small gesture input may relate to a short predefined distance. In an example, if the gesture input has a square shape of each side equal to 40 cm, the predefined distance may be 10 metres, if the gesture input has a square shape of each side equal to 80 cm, the predefined distance may be 20 metres, if the gesture input has a square shape of each side equal to 160 cm, the predefined distance may be 30 metres, and so on. In another example, if the gesture input has a circular shape of radius 5 cm, the predefined distance may be 5 metres; if the gesture input has a circular shape of radius 15 cm, the predefined distance may be 15 metres; and if the gesture input has a circular shape of radius, the predefined distance may be 20 metres.

Optionally, the size of the gesture input is measured by identifying coordinates of the gesture input and mapping the coordinates in a relative manner with respect to the handheld interaction device. The number of times the gesture input is provided in one instance refers to a numerical value of identical gesture inputs provided in a given time period. Moreover, the number of times may vary on how many times the gesture input is provided repetitively and consecutively. One instance of providing the gesture input is one act (or one occurrence) of providing the gesture input. For example, a single gesture input provided in one instance may relate to a short predefined distance, wherein seven consecutive and identical gesture inputs provided in one instance may relate to a long predefined distance. In an example, if the gesture input is provided once, the distance may be 10 metres, if the gesture input is provided twice, the distance may be 20 metres, if the gesture input is provided thrice, the distance may be 30 metres, and so on. It will be appreciated that such above-mentioned factors allow the predefined distance to be defined for each instance of data sharing depending on the gesture input provided via the first handheld interaction device.

Throughout the present disclosure, the term “gesture code” refers to a code assigned to a gesture input. Optionally, a given gesture code is defined using at least one of: an alphabet, a numeral, a special character, an icon, an emoticon. The given set of gesture codes comprises a list of gesture codes with corresponding gesture inputs. It will be appreciated that the given gesture input is mapped to the given gesture code by searching for the given gesture input amongst the given set of gesture codes, and thereby identifying a corresponding gesture code to be the given gesture code. For example, the gesture input ‘square’ may map with the gesture code ‘a’. The first set of gesture codes may either be inbuilt within the first handheld interaction device, or stored by the user of the first handheld interaction device. It will be appreciated that the first set of gesture codes are stored in a first memory of the first handheld interaction device. Herein, the first gesture input is mapped to the first gesture code to identify the first gesture code pertaining to the first gesture input.

Optionally, the step of sharing the first gesture code to the at least one second handheld interaction device is implemented by at least one of: a point-to-point communication, a point-to-multipoint communication. The point-to-point communication may, for example, use an acquire (ACQ) command. Herein, at least the first gesture code is shared by: broadcasting to all second handheld interaction device(s), transmitting to the at least one second handheld interaction device, transmitting to a selected group of second handheld interaction device(s). Optionally, the selected group of second handheld interaction devices lies in a range of 2 to 1000000 handheld interaction devices. Optionally, the selected group of second handheld interaction devices is selected based at least on: a proximity, a location, an age group, a historical similarity, a medical similarity, a shared interest of users.

Optionally, the first gesture input that is provided for sharing the first data from the first handheld interaction device is different for different hands of a user using the first handheld interaction device. As an example, the first gesture input may be a circle gesture for a left hand of the user and a square gesture for a right hand of the user. For example, in a rock concert, the user may make the circle gesture for sharing data with audience on his/her left side and then may make a square gesture for sharing data with audience on his/her right side. In such a case, the user may make the circle gesture and/or the square gesture for sharing data with audience on his/her front side.

Optionally, the step of sharing at least the first gesture code to the at least one second handheld interaction device comprises sharing also a first auxiliary data of the first data, along with the first gesture code, to the at least one second handheld interaction device. The term “auxiliary data” refers to a hash-data or metadata pertaining to the information being shared. Additionally, the term “auxiliary data” further refers to supplementary data that is shared along with the first gesture code to the second handheld interaction device, thereby providing additional information related to the first data. Optionally, such auxiliary data is stored in a memory of a given handheld interaction device. Herein, the first auxiliary data refers to the hash-data or metadata of the first data. The hash-data or metadata includes at least one of: descriptive insights, parameters, contextual details about the information being shared, which enhances an utilization of the first data by the second handheld interaction device; but does not include any content of the information. For example, if the information is an image of a cat, the metadata may be represented as word ‘cat’ instead of having the image or a portion of the image. In a second example, the first data may have a hash code associated therewith, wherein the hash code may be #fe928822, generated using an algorithm to be unique to the first data. This hash code may be utilized along with the first gesture code to assess if the first data is already stored at the at least one second handheld interaction device. It will be appreciated that sharing the first auxiliary data along with the first gesture code provides more options and information to the at least one second handheld interaction device for ensuring correctness of the first gesture code and/or the first data.

Optionally, the method further comprising:
controlling a first interaction element of the first handheld interaction device to provide a first indication at least while sending the first data to a corresponding second handheld interaction device;
upon receiving the first data from the first handheld interaction device, authenticating the first data using the first auxiliary data;
upon successful authentication of the first data, controlling a second interaction element of the corresponding second handheld interaction device to provide a second indication, wherein the second indication is same as the first indication.

The term “interaction element” refers to an element of the handheld interactive device which facilitates interaction with the user. For example, a given interaction element may be a button, a touch screen, a force sensor, a speaker, a vibrator, light-emitting component, and the like. For example, the given interaction element emits a coloured light-based visual indication. The term “indication” refers to a hint or a sign corresponding to a predefined suggestion. Optionally, the given indication is implemented as at least one of: a visual indication, an audio indication, a haptic indication. For example, a visual indication of different colours may represent different situations. With reference to the second example, the first interaction element of the first handheld interaction device may be controlled to provide a green-coloured visual indication (i.e., the first indication) while sending the first data to the corresponding second handheld interaction device. The hash code may be utilised to authenticate the first data. Herein, data stored at the corresponding second handheld interaction device may be checked against the hash code #fe928822 to ascertain if the first data is already stored at the corresponding second handheld interaction device. When the first data is successfully authenticated to be already stored at the corresponding second handheld interaction device, a second interaction element of the corresponding second handheld interaction device may be controlled to provide a green-coloured visual indication (i.e., the second indication). Notably, the gesture input is considered as authentication from the user to receive and, optionally, execute the first data and/or the high-level program code.

It will be appreciated that authenticating information using corresponding auxiliary data saves memory since multiple copies of same information are not stored at the corresponding second handheld interaction device, and saves time since such repetitive transfers of information are discarded.

Optionally, while the corresponding second handheld interaction device is receiving the first data from the first handheld interaction device, the method further comprises controlling the second interaction element to provide a third indication that is different from the first indication. With reference to the second example, the third indication may be implemented as a yellow-coloured visual indication, indicating that the first data is not stored at the corresponding second handheld interaction device but that the corresponding second handheld interaction device wishes to receive the first data. Herein, the gesture code is provided such that the gesture input may be replicated using the corresponding second handheld interaction device for receiving the first data. Optionally, the method further comprises controlling at least one other interaction element of at least one other second handheld interaction device amongst the at least one second handheld interaction device to provide a fourth indication that is different from the first indication. With reference to the second example, the third indication may be implemented as a red-coloured visual indication, indicating that the first data is not stored at the at least one second handheld interaction device and that the at least one second handheld interaction device does not wish to receive the first data. Herein, the gesture code is not provided for replication of the gesture input to receive the first data.

In an example, the first handheld interaction device is used to provide a first gesture input having a square shape, while providing a green indication, and the first gesture input is mapped with a first gesture code. The first gesture code and a first auxiliary data is broadcasted. A second handheld interaction device is used to provide a second gesture input having a square shape, and the second gesture input is mapped with the first gesture code. If the second handheld device has the first auxiliary data stored in its memory, the second handheld interaction device provides a green indication, and the first handheld interaction device shares the first data. However, if the second handheld interaction device does not have the first auxiliary data stored in its memory, the second handheld interaction device provides a yellow indication, and attempts to receive the first data via a cloud database. Herein, cloud settings may be preconfigured in the second handheld interaction device. The cloud database thereon sends the first data to the second handheld interaction device, which provides a green indication. However, if the second handheld interaction device is unable to receive the first data via the cloud database, the first data is received via an external device, wherein the second handheld interaction device is connected to the external device. Thereafter, the second handheld interaction device receives the first data from the external device while providing a green indication.

Optionally, the at least one second gesture input is provided by at least one second user associated with the at least one second handheld interaction device. It will be appreciated that the at least one second gesture input is provided by the at least one second user in response to the first gesture input provided by the first user. Since the first user provides the first gesture input to indicate sharing of the first data, the at least one second gesture input is based on a willingness of the at least one second user to receive the first data. For example, the at least one second user may provide the at least one second gesture input to be same as the first gesture input if the at least one second user wishes to receive the first data. Moreover, the at least one second user may provide the at least one second gesture input to be different from the first gesture input if the at least one second user does not wish to receive the first data.

Herein, the at least one second gesture input is mapped to the at least one second gesture code to identify if the at least one second set of gesture codes contains the at least one second gesture code pertaining to the at least one second gesture input. The at least one second set of gesture codes may either be inbuilt within the at least one second handheld interaction device, or stored by the at least one second user of the at least one second handheld interaction device. It will be appreciated that the at least one second set of gesture codes are stored in at least one second memory of the at least one second handheld interaction device. Optionally, the first set of gesture codes is same as the second set of gesture codes. Herein, a same gesture input would correspond to a same gesture code. In a third example, if the first user provides a circle as the first gesture input mapping with the first gesture code ‘a’, when a second user provides a circle as a second gesture input via HID (i.e., handheld interaction device) 1, it will map with a second gesture code ‘a’ to indicate willingness to receive the first data. Alternatively, optionally, the first set of gesture codes is different than the second set of gesture codes. Herein, a same gesture input may correspond to: a same gesture code having same indication, a different gesture code having same indication, a same gesture code having different indication, or a different gesture code having different indication. With reference to the third example, the second gesture input of the circle may map with: the second gesture code ‘a’ indicating willingness to receive the first data by HID 1, a second gesture code ‘b’ indicating willingness to receive the first data by HID 2, a second gesture code ‘a’ indicating unwillingness to receive the first data by HID 3, a second gesture code ‘b’ indicating unwillingness to receive the first data by HID 4.

Moreover, the first gesture code is compared with the at least one second gesture code by comparing the gesture codes as well as their corresponding indications. With reference to the third example, the first gesture code ‘a’ indicating a willingness to share data via the first handheld interaction device is compared with the second gesture code ‘a’ indicating willingness to receive the first data by HID 1, the second gesture code ‘b’ indicating willingness to receive the first data by HID 2, the second gesture code ‘a’ indicating unwillingness to receive the first data by HID 3, and the second gesture code ‘b’ indicating unwillingness to receive the first data by HID 4. Herein, since the second gesture code ‘a’ of HID 1 and the second gesture code ‘b’ of HID 2 indicate willingness to receive the first data, they correspond to the first gesture code ‘a’ and are thereby considered equal to the first gesture code.

Furthermore, when the second gesture code is equal to the first gesture code, the corresponding second handheld interaction device is activated to receive the first data. Herein, the term “corresponding second handheld interaction device” refers to the second handheld interaction device(s) whose second gesture code(s) are equal to (i.e., matches) the first gesture code. It will be appreciated that the first data will be sent only to the corresponding second handheld interaction device, and not to other second handheld interaction devices. Optionally, activating the corresponding second handheld interaction device comprises sending a command from the corresponding second handheld interaction device to the first handheld interaction device, wherein the command indicates readiness of the corresponding second handheld interaction device for receiving the first data.

Optionally, the activation of the corresponding second handheld interaction device is implemented as one of: immediate activation, activation after a random delay in the corresponding second handheld interaction device, activation after a preselected delay in the corresponding second handheld interaction device, wherein the delay is indicated in the first auxiliary data of the first data. It will be appreciated that the delay enables fast data sharing and avoids network overloading, since the first data is gradually being downloading during the delay in activation of the corresponding second handheld interaction device to other corresponding second handheld interaction devices.

Optionally, when the second gesture code is not equal to the first gesture code, the method further comprises:
determining that the first data is not to be sent to a corresponding second handheld interaction device; or
waiting to detect at least one next second gesture input that is providable in future from a corresponding second handheld interaction device.

With reference to the third example, the second gesture code ‘a’ indicating unwillingness to receive the first data by HID 3, and the second gesture code ‘b’ indicating unwillingness to receive the first data by HID 4 were mapped to not be equal to the first gesture code ‘a’. Herein, the first data is not sent to the corresponding handheld interaction device (i.e., HID 3 and HID 4) unless the at least one next second gesture input corresponding to a next second gesture code is equal to the first gesture code.

Optionally, the first data from the first handheld interaction device is sent to the corresponding second handheld interaction device wirelessly. Optionally, the sending of such data is implemented as at least one of: a Bluetooth-based communication, an infrared communication, a radio broadcast, a satellite communication, a microwave communication, a wireless fidelity (Wi-Fi) communication, a wireless local area network (WLAN). Optionally, the method further comprises releasing a communicative coupling between the first handheld interaction device and the corresponding second handheld interaction device upon successful reception of the first data at the corresponding second handheld interaction device. It will be appreciated that releasing of the communicative coupling protects the handheld interaction devices from hacking, and saves battery power which would otherwise be invested in maintaining such communicative coupling.

Optionally, the method further comprises:
detecting a validation gesture input that is provided using the corresponding second handheld interaction device, upon receipt of the first data at the corresponding second handheld interaction device; and
enabling access to the first data when the validation gesture input matches the second gesture input.

It will be appreciated that the validation gesture acts as a confirmation from the user of the corresponding second handheld interaction device that the first data has been received. Beneficially, the user cannot access the first data while receiving the first data since that may cause the data to get corrupted, and therefore allowing access once the validation gesture input is received circumvents such issues that may otherwise arise. Optionally, the communicative coupling between the first handheld interaction device and the corresponding second handheld interaction device is released after detecting the validation gesture input.

Optionally, the step of sending the first data from the first handheld interaction device to the corresponding second handheld interaction device comprises activating data transmission upon detecting an activation input that is provided to the first handheld interaction device and transferring the first data to the corresponding second handheld interaction device upon the activation of the data transmission. The term “activation input” refers to an input provided by the user via the first handheld interaction device, wherein receipt of such input activates data transmission of the first data to the corresponding second handheld interaction device. Optionally, the activation input is provided by at least one of: touching the first handheld interaction device in a required manner (for example, tapping, squeezing, and the like), giving a voice command, giving a touch input, shaking the first handheld interaction device. It will be appreciated that activation of the data transmission upon detecting the activation input provides an additional layer of data protection, allowing the first handheld interaction device to confirm sharing of data once prior to transmission, such that the first data is not sent to any unauthorised device or person.

Optionally, in this regard, the first handheld interaction device comprises a housing and at least one of: a magnetic sensor arranged inside the housing and a magnet arranged on an outer surface of the housing, a force sensitive resistor arranged on the outer surface of the housing, an electromechanical film arranged on the outer surface of the housing, and wherein the step of detecting the activation input that is provided to the first handheld interaction device comprises measuring at least one of: change of magnetic field of the magnet, change of resistance from the force sensitive resistor, change of charge from the electromechanical film.

The housing is utilised as a casing for holding and safeguarding components of the handheld interaction device. Moreover, the housing is an integrated housing, such that all elements of the handheld interaction device are installed within the housing. Optionally, a shape of the housing is a three-dimensional symmetric shape. For example, the shape of the housing may be a cube, a sphere, a tetrahedron, an octahedron, a hexagonal polyhedron, and the like. Alternatively, optionally, a shape of the housing is a three-dimensional unsymmetrical shape. For example, the shape of the housing may be a cuboid, a cylinder, a prism, a pyramid, and the like. The housing allows the handheld interaction device to maintain its structural integrity. Optionally, the housing is made of an elastic material. In such a case, although the housing may get pressed under pressure, it will regain its structure once the pressure is released. The housing may, for example, be made of an elastomer such as rubber. Alternatively, optionally, the housing is made of an inelastic material.

The term “magnetic sensor” refers to a sensor which detects and measures magnetic fields. Herein, the magnetic sensor is configured to measure change of magnetic field of the at least one magnet to detect if the handheld interaction device is squeezed. Examples of the magnetic sensor includes, but is not limited to a hall sensor, a semiconducting magnetoresistor sensor, a ferromagnetic magnetoresistor sensor, a fluxgate sensor, a superconducting quantum interference device (SQUID) sensor, a resonant sensor, an induction magnetometer sensor, a linear variable differential transformer sensor, an inductosyn sensor, a synchro sensor, a resolver sensor. The magnetic field is produced by the magnet arranged on the outer surface of the housing. Optionally, the magnet is implemented as at least one of: a permanent magnet, a temporary magnet, an electromagnet. Since the housing of the handheld interaction device is flexible, when the handheld interaction device is pressed (for example, even slightly pressed by the action of holding the handheld interaction device), a position of the magnet on the housing changes, causing a change in the magnetic field produced by the magnet. The magnetic sensor senses this change in the magnetic field. The term “force sensitive resistor” refers to a sensor which measures and/or detects a change in force by measuring a change in resistance therein. Examples of the at least one force sensitive resistor include but are not limited to a shunt-mode force sensitive resistor, a thru-mode force sensitive resistor. The “electromechanical film” refers to a thin, flexible film which can function as a sensor. The electromechanical film has a voided internal structure, such that when it is pressed, a thickness of the electromechanical film changes, thereby indicating pressure for detecting if the handheld interaction device is squeezed. A technical advantage of using the above-mentioned sensors is that they accurately detect the activation input that is provided to the first handheld interaction device.

Optionally, after the first data is transferred to the at least one second handheld device, the first data is deleted from the first handheld device. Herein, the first data may be a FIFO (first-in, first-out) type of data, which is removed from a source after transfer. This is appreciated because it regularly frees up the memory of the first handheld interaction device, and ensures appropriate working of the same.

Optionally, the method further comprises:
sharing at least the second gesture code to at least one third handheld interaction device;
detecting at least one third gesture input that is provided using the at least one third handheld interaction device;
mapping the at least one third gesture input to at least one third gesture code from amongst at least one third set of gesture codes that are stored in the at least one third handheld interaction device;
comparing the second gesture code with the at least one third gesture code for determining whether a third gesture code amongst the at least one third gesture code is equal to the second gesture code;
when the third gesture code is equal to the second gesture code, activating a corresponding third handheld interaction device amongst the at least one third handheld interaction device for receiving the first data; and
sending the first data from the corresponding second handheld interaction device to the corresponding third handheld interaction device.

Herein, the first data, which has been shared to the corresponding second handheld interaction device previously is now to be shared with the at least one third handheld interaction device. Optionally, at least the second gesture code is shared by: broadcasting to all other handheld interaction devices, transmitting to at least one other handheld interaction device, transmitting to a selected group of other handheld interaction devices. Optionally, the second gesture code is same as the first gesture code. Alternatively, optionally, the second gesture code is different than the first gesture code. It will be appreciated that the at least one third gesture input is provided by at least one third user using the at least one third handheld interaction device in response to the second gesture code. Herein, the at least one third gesture input is based on a willingness of the at least one third user to receive the first data. Thereafter, at least one third gesture input is mapped to the at least one third gesture code to identify if the at least one third set of gesture codes contains the at least one third gesture code pertaining to the at least one third gesture input. The at least one third set of gesture codes may either be inbuilt within the at least one third handheld interaction device, or stored by the at least one third user of the at least one third handheld interaction device. It will be appreciated that the at least one third set of gesture codes are stored in at least one third memory of the at least one third handheld interaction device. Moreover, the second gesture code is compared with the at least one third gesture code by comparing the gesture codes as well as their corresponding indications. Furthermore, when the third gesture code is equal to the second gesture code, the corresponding second handheld interaction device is activated to receive the first data, and the first data is sent to the corresponding third handheld interaction device. It will be appreciated that such sharing of the first data from the corresponding second handheld interaction device to the corresponding third handheld interaction devices is time-saving and efficient, since it allows a handheld interaction device having the first data to share the first data with other handheld interaction devices. Optionally, the method further comprises releasing a communicative coupling between the corresponding second handheld interaction device and the corresponding third handheld interaction device upon successful reception of the first data at the corresponding third handheld interaction device.

Optionally, the method further comprises:
detecting a set of gesture inputs provided using a handheld interaction device, wherein each gesture input in the set is one of: a predefined gesture input, a user-defined gesture input;
storing the set of gesture inputs and a set of gesture codes in the handheld interaction device;
linking each gesture input in the set of gesture inputs to a corresponding gesture code in the set of gesture codes; and
storing information indicative of said linking in the handheld interaction device.

Herein, the set of gesture inputs are being stored and linked with corresponding gesture codes for the handheld interaction device. The handheld interaction is device is implemented as at least one of: the first handheld interaction device, the at least one second handheld interaction device, and the at least one third handheld interaction device. The set of gesture inputs are detected by capturing gestures provided by the user, and stored along with the set of gesture codes in the handheld interaction device. Herein, the set of gesture inputs, the set of gesture codes, and the information indicative of linking between the gesture inputs and gesture codes are stored at a memory of the handheld interaction device. Thereafter, each gesture input is linked with a corresponding gesture code depending on if the gesture input is the predefined gesture input or if the gesture input is the user-defined gesture input. If the gesture input is the predefined gesture input, then the linking of the gesture input with the gesture code is predefined during manufacturing. For example, for the predefined gesture input ‘circle’, a predefined gesture code ‘a1’ may be linked therewith. Alternatively, if the gesture input is the user-defined gesture input, the user may assign the corresponding gesture code to said gesture input, or the gesture code may be assigned autonomously for the same. User-defined gesture inputs offer customizability in terms of gesture inputs that are used for communication of data. Such linking information assists in comparing two or more gesture inputs with each other to identify similarity or dissimilarity. It will be appreciated that such detection and storing of gesture inputs, and linking of the gesture inputs to the gesture codes allows fast and efficient comparison of multiple gesture inputs, making the data sharing between multiple handheld interaction devices fast, reliable and effortless for the users.

Optionally, the method further comprises:
activating a learning mode of a handheld interaction device for enabling the handheld interaction device to learn a user-defined gesture input;
recording a training gesture input that is provided repeatedly using the handheld interaction device during the learning mode, wherein a number of repetitions of the training gesture input is predefined;
determining a similarity score of the repetitions of the training gesture input; and
determining the user-defined gesture input to be the training gesture input, when the similarity score is equal to or greater than a similarity threshold.

The term “learning mode” refers to a setting of the handheld interaction device wherein the handheld interaction device is trained to record, learn and thereby store user-defined gesture inputs. The learning mode is optionally activated using a predefined gesture input, or by any other suitable activation mechanism (for example, pressing of a button). Examples of such predefined gesture inputs include, but are not limited to, tapping the handheld interaction device at a designated area of the handheld interaction device, squeezing the handheld interaction device, pressing a button on the handheld interaction device, drawing a gesture on a touch-receptive portion of the handheld interaction device, drawing a gesture in air holding the handheld interaction device.

The training gesture input is a gesture input provided to the handheld interaction device during training in the learning mode. Herein, the training gesture input could be provided to the handheld interaction device using at least one of: a motion-based gesture training, a touch-based gesture training, a compressive force-based gesture training.

When training the handheld interaction device using the motion-based gesture training, the training gesture input may include, but is not limited to, drawing the gesture in air holding the handheld interaction device. When training the handheld interaction device using the touch-based gesture training, the training gesture input may include, but is not limited to, pressing of the button on the handheld interaction device, tapping the handheld interaction device at the designated area of the handheld interaction device, drawing the gesture on a touch-receptive portion of the handheld interaction device, and tapping while simultaneously drawing the handheld interaction device at the designated area of the handheld interaction device. When training the handheld interaction device using the compressive force-based gesture training, the training gesture input may include, but is not limited to, squeezing the handheld interaction device, and squeezing while simultaneously drawing the handheld interaction device. Beneficially, when the handheld interaction device is trained using the compressive force-based gesture training, the training gesture input is hard to duplicate by an observer, as said observer can only observe the shape of the training gesture input but not an intensity of the simultaneous squeezing of the handheld interaction device. For example, the training gesture input which is correctly trained may be a gesture input that may include drawing a circular shape in the air while simultaneously squeezing the handheld interaction device at an upper part of the circular shape. Optionally, the user provides the training gesture input repeatedly, for at least the predefined number of times. For example, 10 repetitions of the training gesture input may be required for learning any training gesture input. In this case, the user may provide the training gesture input at least 10 times repeatedly for the handheld interaction device to record the training gesture input. Once recorded, the similarity score of the repetitions of the training gesture input is determined.

Optionally, the similarity score is determined by employing a similarity algorithm. The similarity gesture maps the repetitions of the training gesture input to identify similarities and dissimilarities in at least one of: a shape, a size, a node, of the repetitions of the training gesture input. Optionally, the similarity score is determined using all repetitions of the training gesture input. For example, if 10 repetitions of the training gesture input are recorded, then all 10 repetitions of the training gesture input may be utilised to determine the similarity score. Alternatively, optionally, the similarity score is determined using some of the repetitions of the training gesture input. For example, if 10 repetitions of the training gesture input are recorded, 3 best repetitions of the training gesture input may be utilised to determine the similarity score. A high similarity score is observed when the repetitions of the training gesture input are consistent, and a low similarity score is observed when the repetitions of the training gesture input are inconsistent with each other. Optionally, the similarity score may be provided as: a percentage, a grade, a number of marks. Since only the repetitions of the training gesture input having the high similarity score are useful for learning, any training gesture input having a similarity score lower than the similarity threshold is not determined as the user-defined gesture input.

The term “similarity threshold” refers to a minimum similarity score that the repetitions of the training gesture input is required to have to be determined as the user-defined gesture. For example, if the similarity threshold is 70%, repetitions of a first training gesture input have a similarity score of 65% and repetitions of a second training gesture input have a similarity score of 82%, then the second training gesture input may be determined as the user-defined gesture input since it's similarity score is higher than the similarity threshold and the first training gesture input may not be determined as the user-defined gesture input since it's similarity score is lower than the similarity threshold. It will be appreciated that such learning mode enables the handheld interaction device to be customised to suit individual user requirements, while also promoting accessibility for the users. Optionally, the method further comprises storing the user-defined gesture input in the handheld interaction device. Herein, the user-defined gesture input is stored in the memory of the handheld interaction device.

Optionally, the first data comprises information of a second data that is stored in an external device, the information includes at least a network address of the external device, wherein the method further comprises:
sending a command from the corresponding second handheld interaction device to the network address of the external device, wherein the command indicates readiness of the corresponding second handheld interaction device for receiving the second data; and
sending the second data from the external device to the corresponding second handheld interaction device, upon receiving the command at the external device.

The term “external device” refers to a communication device having a memory and data communication capabilities. The external device may, for example, be a cloud server, a LAN device, a Bluetooth-enabled device, a computer, a laptop, a smartphone, or similar. Optionally, the data is at least one of: the first data, the second data. Optionally, a size of the second data is greater than a size of the first data. In such a case, the second data is stored in the external device and is shared therefrom. Optionally, information of a data comprises at least one of: access rights of the data, a network address of a device at which the data is stored.

The term “network address of the external device” refers to a unique identifier to determine a location of the external device in a network. The network address of the external device is a part of an internet protocol address (i.e., IP address) of the external device, which comprises the network address and a host address. The network address and the host address are a set of numbers that are associated with the external device, wherein the network address provides information of a subnetwork in which the external device is located, and the host address provides information of the location of the external device in the subnetwork. The IP address, for example, enables the external device to send or receive data. For example, 192.168.123.132 is the IP address consisting of the network address 192.168.123.0 and the host address 0.0.0.132. The term “access rights” refers to a permission that is granted to the given handheld interaction device to access (i.e., locate and read) the data. Optionally, access rights of the data comprise information pertaining to at least one of: a number of times the data can be shared, a time of sharing the data, a time of storing the data in a corresponding handheld interaction device, whether the data can be re-shared, a number of times the data can be re-shared, whether the data can be deleted from the corresponding handheld interaction device after a preselected time, the preselected time for deleting the data, metadata of the device at which the data is stored.

The term “command” refers to an intimation sent from the corresponding second handheld interaction device to the network address of the external device indicating readiness of the corresponding second handheld interaction device for receiving the second data. For example, the command may be expressed in binary codes like 0 and 1, where the command ‘0’ may mean that the external device is not ready to receive data from the corresponding second handheld interaction device, and the command ‘1’ may mean that the external device is ready to receive the data from the corresponding second handheld interaction device. The second data may or may not be sent from the external device to the corresponding second handheld interaction device depending on the command received at the external device in real-time. For example, if the command indicates readiness of the corresponding second handheld interaction device for receiving the second data, then the second data would be sent from the external device. However, if the command does not indicate readiness of the corresponding second handheld interaction device for receiving the second data, then the second data would not be shared. It will be appreciated that the method of sending the data via the external device saves memory and battery of the handheld interaction device.

Optionally, the method further comprises confirming successful reception of the first data at the corresponding second handheld interaction device by controlling at least one interaction element for providing at least one indication, the at least one indication being at least one of: a visual indication, an audio indication, a vibration indication, some other physical indication. The term “visual indication” refers to an indication that can be detected visually, by an eye of the user. For example, a green LED (i.e., light emitting diode) may indicate successful reception of the first data at the corresponding second handheld interaction device. The term “audio indication” refers to an indication that can be aurally detected by an ear of the user. For example, a notification sound may indicate successful reception of the first data at the corresponding second handheld interaction device. The term “vibration indication” refers to an indication that can be detected haptically, by touch of the user. Herein, the vibration indication could be applied at a certain point of the gesture input. As an example, when the gesture input has a circular shape. Herein, at an upper part of the circular shape, the user may squeeze the interaction element of the handheld interaction device, and a response may be a vibration at a lower part of the circular shape. For example, to be able to show a gesture password with a gesture input, when there is a circular shape to be followed as a gesture input which requires two squeezes at top and one squeeze at bottom. In case a user has forgotten the gesture password it would be possible to reproduce it with a certain external device command e.g., show gesture password, which makes the handheld interaction device to vibrate at certain points of the circular shape that the user would know where to squeeze the interaction element of the handheld interaction device when the user is performing it. In this case when the user is making a circle shape with the handheld interaction device it would vibrate twice at top and once at the bottom to indicate to the user that the actual gesture input with the correct gesture password would require two squeezes at top and one at bottom. In other example, a pulse may be generated in the corresponding second handheld interaction device to indicate successful reception of the first data at the corresponding second handheld interaction device. Similarly, the reception of the second data at the corresponding handheld interaction device, and the reception of the first data at the corresponding third handheld interaction device comprise confirming the successful reception. Optionally, a handheld interaction device comprises the at least one interaction element that is controllable for providing the at least one indication, the at least one interaction element being implemented as at least one of: a display, a loudspeaker, a vibration element. Herein, the display may provide the visual indication, the loudspeaker may provide the audio indication and the vibration element may provide the vibration indication for confirming successful reception of the first data at the corresponding second handheld interaction device. It will be appreciated that such indication confirming reception of data at the corresponding second handheld interaction device eases the step of detecting when transfer of the data is complete, saving additional processing and therefore battery. Optionally, the at least one interaction element of the corresponding second handheld interaction device is utilised to send an acquire command back to the first handheld interaction device, when the first handheld interaction device and the corresponding second handheld interaction device are engaged in a point-to-point communication.

The present disclosure also relates to the system for sharing data amongst handheld interaction devices as described above. Various embodiments and variants disclosed above, with respect to the aforementioned first aspect, apply mutatis mutandis to the system.

Throughout the present disclosure, the term “processor” refers to hardware, software, firmware, or a combination of these configured to control operation of the aforementioned handheld interaction device. In this regard, the processor performs several complex processing tasks. The processor is communicably coupled to other components of the handheld interaction device wirelessly and/or in a wired manner. In an example, the processor may be implemented as a programmable digital signal processor (DSP). In another example, the processor may be implemented via a cloud server that provides a cloud computing service. It will be appreciated that different processor may perform different functions for appropriate functioning of the system.

Optionally, the at least one memory maintains a first database and a second database, wherein the first database is configured to store the data, and the second database is configured to store the set of gesture inputs, the set of gesture codes, and the information indicative of the linking of each gesture input in the set of gesture inputs to the corresponding gesture code in the set of gesture codes. The at least one memory and the processor are communicably coupled, such that data and commands are easily transferred between them. Moreover, the processor controls operations of the handheld interaction device.

Optionally, the at least one memory comprises a first memory and a second memory, wherein the first memory is configured to store the data, and the second memory is configured to store the set of gesture inputs, the set of gesture codes, and the information indicative of the linking of each gesture input in the set of gesture inputs to the corresponding gesture code in the set of gesture codes.

Optionally, the system further comprises an external processor of an external device, the external device having a second data stored thereat, wherein the first data comprises information of the second data, the information including at least a network address of the external device, and wherein the external processor is configured to:
receive a command that is sent from the corresponding second handheld interaction device to the network address of the external device, wherein the command indicates readiness of the corresponding second handheld interaction device for receiving the second data; and
send the second data from the external device to the corresponding second handheld interaction device.

The external processor refers to a processor other than the processor of the handheld interaction devices. Optionally, the external processor is implemented as at least one of: a processor of an external device, an external server.

The present disclosure also relates to the handheld interaction device as described above. Various embodiments and variants disclosed above, with respect to the aforementioned first aspect and the second aspect, apply mutatis mutandis to the handheld interaction device.

The battery is a source of electric power, which is used to power components of the handheld interaction device. Optionally, the battery is a disposable battery. In such a case, the battery can only be utilized for single use, and must be replaced with a similar battery. For example, the battery in a watch is often a disposable battery and must be replaced every few years. Examples of disposable batteries include, but are not limited to, zinc-carbon (Leclanché) batteries, alkaline zinc-manganese dioxide batteries, metal-air-depolarized batteries. Alternatively, optionally, the battery is a rechargeable battery. In such a case, the battery can be recharged and used multiple times. Examples of rechargeable batteries include, but are not limited to, lead-acid batteries, nickel-cadmium (NiCd) batteries, nickel-metal hydride (NiMH) batteries, lithium-ion (Li-ion) batteries, lithium-ion polymer (LiPo) batteries, rechargeable alkaline batteries. The communication interface refers to an interface which enables communication of the handheld interaction device with other handheld interaction devices and/or an external device. Such communication interface optionally enables a wireless communication. Optionally, the communication interface is implemented using at least one of: a wireless local area network (WLAN), a bluetooth network, a wireless fidelity network, a near-field communication network. Throughout the present disclosure, the term “sensor” refers to an element which detects contact of the handheld interaction device with a surface. For example, if the handheld interaction device is held in a hand of the user, the at least one sensor detects contact of the handheld interaction device with the hand of the user.

The at least one memory is utilised for storing data pertaining to the handheld interaction device. The at least one memory may be a local memory that is integrated with the processor, may be an external memory, may be a cloud-based memory, or similar. Optionally, the at least one memory maintains a first database and a second database, wherein the first database is configured to store the data, and the second database is configured to store the set of gesture inputs, the set of gesture codes, and the information indicative of the linking of each gesture input in the set of gesture inputs to the corresponding gesture code in the set of gesture codes. Alternatively, optionally, the at least one memory comprises a first memory and a second memory, wherein the first memory is configured to store the data, and the second memory is configured to store the set of gesture inputs, the set of gesture codes, and the information indicative of the linking of each gesture input in the set of gesture inputs to the corresponding gesture code in the set of gesture codes.

Optionally, the handheld interaction device further comprises an interaction element that is controllable to provide an indication.

Optionally, the at least one sensor is implemented as at least one of: an accelerometer, a gyroscope, a magnetometer, and wherein the processor is configured to process sensor data generated by the at least one sensor to detect a gesture input. The accelerometer measures the vibration, or acceleration of motion of the handheld interaction device. Herein, the accelerometer detects the gesture input received from the handheld interaction device by measuring orientation values and location values of the handheld interaction device in a three-dimensional coordinate structure (i.e., it measures the orientation values and location values in an x axis, a y axis, and a z axis). The gyroscope comprises a spinning wheel or disc wherein the axis of rotation is free to assume any orientation by itself, indicating a change in the rotation of the handheld interaction device. The magnetometer measures direction, strength, or relative change of a magnetic field at a particular location. It will be appreciated that the at least one sensor being implemented in the above-mentioned manner provides information of the input gesture being made.

Optionally, the handheld interaction device is used by a user for at least one of: an indoor activity, an outdoor activity, and wherein a given activity pertains to at least one of: gaming, entertainment, education, software development and testing, simulation. Optionally, the given activity further pertains to infotainment. It will be appreciated that usage of the handheld interaction device is not restricted to a particular environment, and it may be utilised for both indoor and outdoor activities. Moreover, as mentioned above, the handheld interaction device may be utilised for multiple activities. In an example, when the handheld interaction device is being utilised for gaming, apps may be shared using the handheld interaction device. In another example, when the handheld interaction device is utilised for a concert, a new song may be shared with all concert attendees using the handheld interaction device. In yet another example, when the handheld interaction device is utilised for infotainment, said handheld interaction device combines the at least one interaction element to a real-time entertainment program running on an infotainment system. Herein, a smart home connection may be used to combine the handheld interaction device with the infotainment system, by transmitting data via a cloud server to a premises of the infotainment system.

Optionally, the handheld interaction device further comprises at least one of: a magnetic sensor arranged inside the housing and a magnet arranged on an outer surface of the housing, a force sensitive resistor arranged on the outer surface of the housing, an electromechanical film arranged on the outer surface of the housing, of the first handheld interaction device.

Optionally, the handheld interaction device is implemented as one of: a ball-type device, a dice-type device, a bar-type device, a coin-type device, a wearable device, any other type of device. It will be appreciated that the handheld interaction device may be implemented in a variety of shapes and sizes to suit a variety of users. Herein, the ball-type device, the dice-type device and the coin-type device are implementations of the handheld interaction device being utilised as an interactive toy or gaming console. The bar-type device is an implementation where the handheld interaction device may be utilised as a smartphone or a tablet. The wearable device is an implementation wherein the handheld interaction device is utilised as a wearable hand gear, for example, a wearable watch.

### DETAILED DESCRIPTION OF THE DRAWINGS

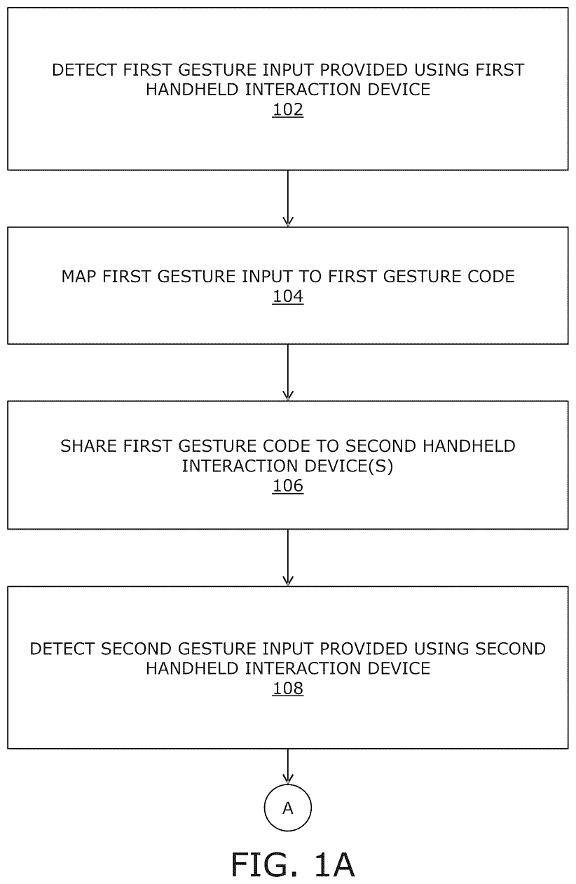

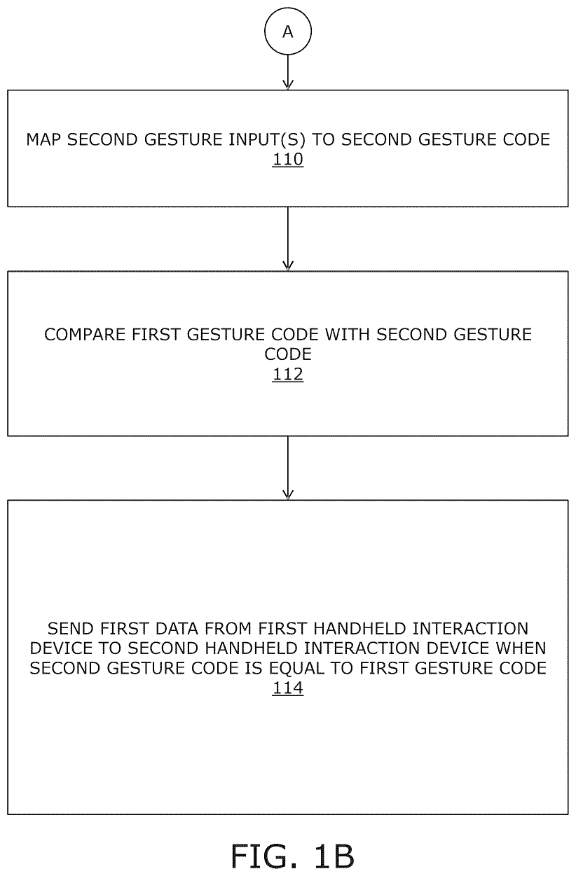

Referring to FIG. 1, illustrated are steps of a method for sharing data amongst first and second handheld interaction device, in accordance with an embodiment of the present disclosure. At step 102, a first gesture input that is provided using a first handheld interaction device is detected, wherein the first gesture input is an activity related to sharing a first data from the first handheld interaction device to at least one second handheld interaction device that is within a first distance from the first handheld interaction device. At step 104, the first gesture input is mapped to a first gesture code from amongst a first set of gesture codes that are stored in the first handheld interaction device. At step 106, the first gesture code is shared to the at least one second handheld interaction device. At step 108, at least one second gesture input that is provided using the at least one second handheld interaction device is detected. At step 110, the at least one second gesture input is mapped to at least one second gesture code from amongst at least one second set of gesture codes that are stored in the at least one second handheld interaction device. At step 112, the first gesture code is compared with the at least one second gesture code for determining whether a second gesture code amongst the at least one second gesture code is equal to the first gesture code. At step 114, the first data is sent from the first handheld interaction device to the corresponding second handheld interaction device, when the second gesture code is equal to the first gesture code, activating a corresponding second handheld interaction device amongst the at least one second handheld interaction device for receiving the first data.

The steps 102, 104, 106, 108, 110, 112 and 114 are only illustrative and other alternatives can also be provided where one or more steps are added, one or more steps are removed, or one or more steps are provided in a different sequence without departing from the scope of the claims herein.

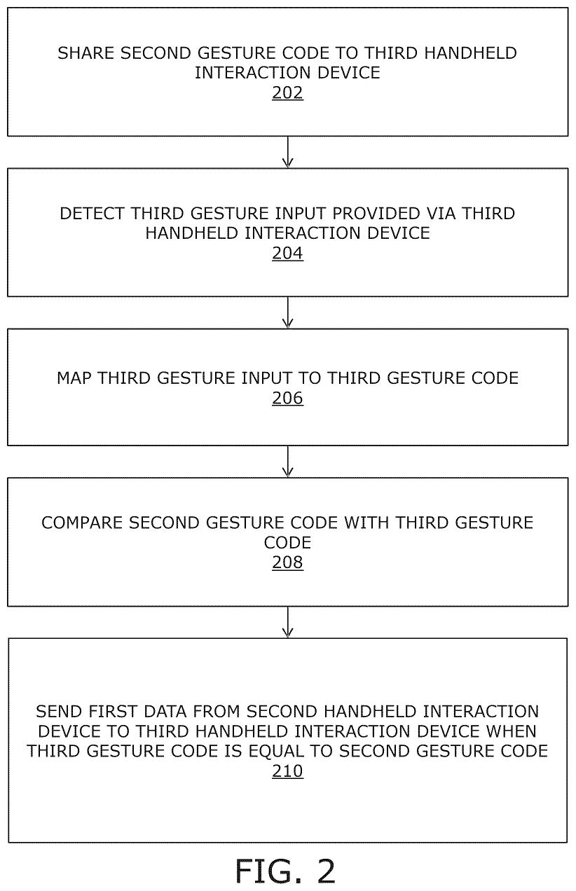

Referring to FIG. 2, illustrated are steps of a method for sharing data amongst second and third handheld interaction device, in accordance with an embodiment of the present disclosure. At step 202, a second gesture code is shared to at least one third handheld interaction device that is within a second distance from a corresponding second handheld interaction device. At step 204, at least one third gesture input that is provided using the at least one third handheld interaction device is detected. At step 206, the at least one third gesture input is mapped to at least one third gesture code from amongst at least one third set of gesture codes that are stored in the at least one third handheld interaction device. At step 208, the second gesture code is compared with the at least one third gesture code for determining whether a third gesture code amongst the at least one third gesture code is equal to the second gesture code. At step 210, the first data from the corresponding second handheld interaction device is sent to the corresponding third handheld interaction device when the third gesture code is equal to the second gesture code, activating a corresponding third handheld interaction device amongst the at least one third handheld interaction device for receiving the first data.

The steps 202, 204, 206, 208 and 210 are only illustrative and other alternatives can also be provided where one or more steps are added, one or more steps are removed, or one or more steps are provided in a different sequence without departing from the scope of the claims herein.

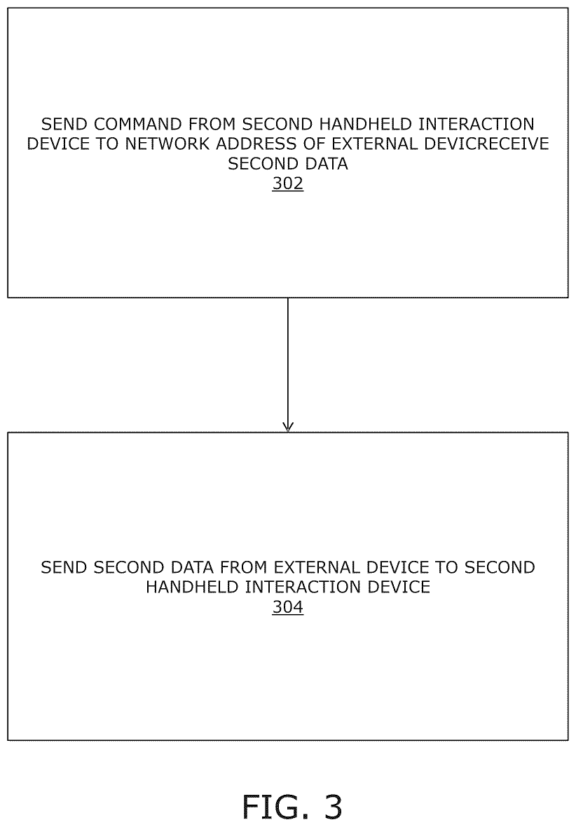

Referring to FIG. 3, illustrated are steps of a method for sharing data amongst handheld interaction devices, in accordance with an embodiment of the present disclosure. Herein, first data comprises information of a second data that is stored in an external device, the information including at least a network address of the external device. At step 302, a command from a corresponding second handheld interaction device is sent to the network address of the external device, wherein the command indicates readiness of the corresponding second handheld interaction device for receiving the second data. At step 304, the second data from the external device is sent to the corresponding second handheld interaction device, upon receiving the command at the external device.

The steps 302 and 304 are only illustrative and other alternatives can also be provided where one or more steps are added, one or more steps are removed, or one or more steps are provided in a different sequence without departing from the scope of the claims herein.

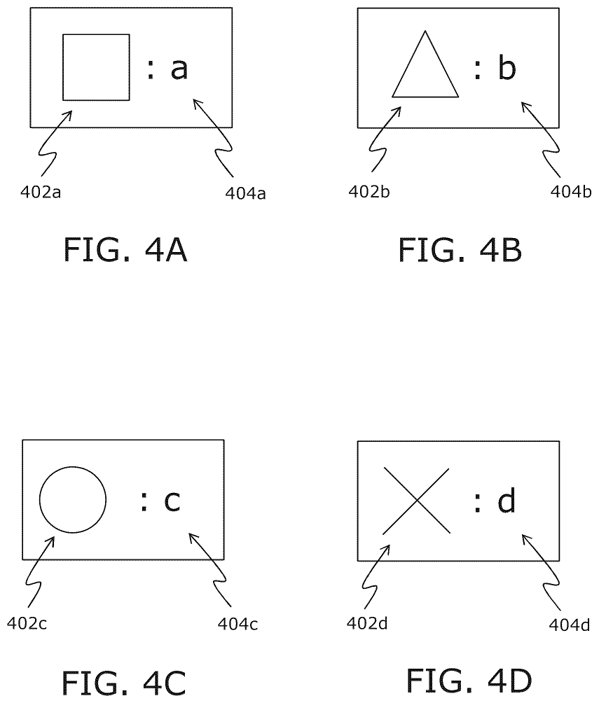

Referring to FIGS. 4A, 4B, 4C and 4D illustrate an exemplary set of gestures and corresponding gesture codes, in accordance with an embodiment of the present disclosure. The set of gestures 402a, 402b, 402c, 402d (hereinafter, collectively referred to as 402) correlate with the corresponding gesture codes 404a, 404b, 404c, 404d (hereinafter, collectively referred to as 404). The set of gestures 402 are provided via at least one handheld interaction device. In FIG. 4A, a gesture 402a is represented as a square and the corresponding gesture code 404a is represented as alphabet ‘a’. In FIG. 4B, a gesture 402b is represented as a triangle and the corresponding gesture code 404b is represented as alphabet ‘b’. In FIG. 4C, a gesture 402c is represented as a circle and the corresponding gesture code 404c is represented as alphabet ‘c’. In FIG. 4D, a gesture 402d is represented as an X and the corresponding gesture code 404d is represented as alphabet ‘d’.

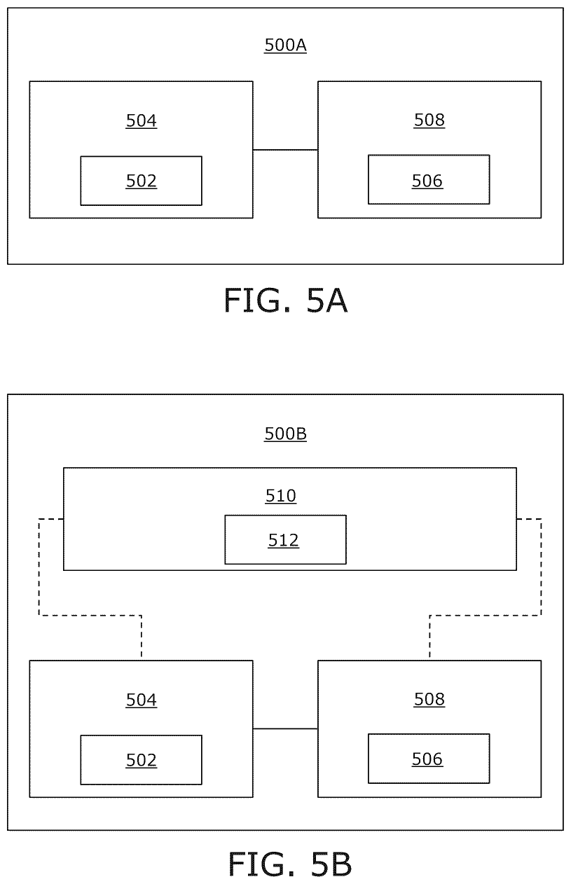

Referring to FIGS. 5A and 5B, illustrated is a system 500A and 500B (hereinafter, collectively referred as 500) for sharing data amongst handheld interaction devices 502 and 504 (implemented as a first handheld interaction device 502 and a second handheld interaction device 504), in accordance with an embodiment of the present disclosure. The system 500 comprises—a first processor 506 of a first handheld interaction device 502; and at least one second processor 508 of at least one second handheld interaction device 504. Herein, the first handheld interaction device 502 and the second handheld interaction device 504 are communicably coupled.

In FIG. 5A, illustrated is a system 500A for sharing data amongst handheld interaction devices 502 and 504, that are communicably coupled, in accordance with an embodiment of the present disclosure. In FIG. 5B, illustrated is a system 500B for sharing data amongst handheld interaction devices 502 and 504, and an external device 510, in accordance with an embodiment of the present disclosure. The system 500B further comprises an external processor 512 of the external device 510.

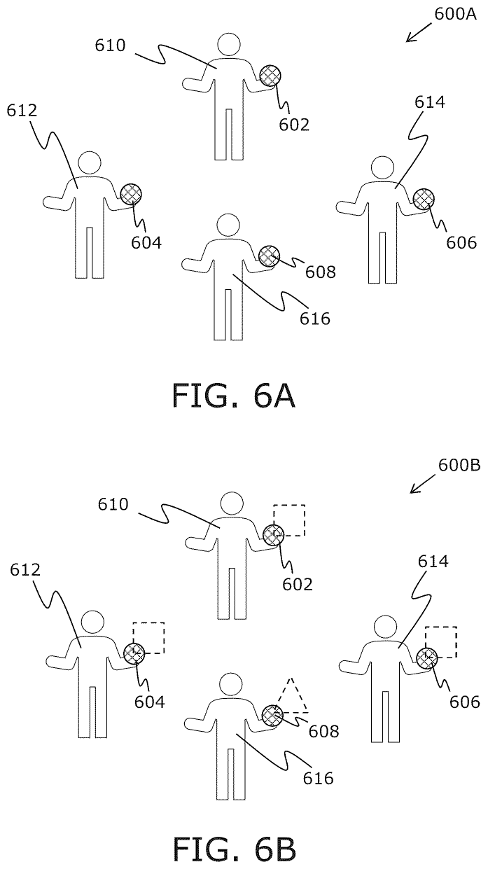

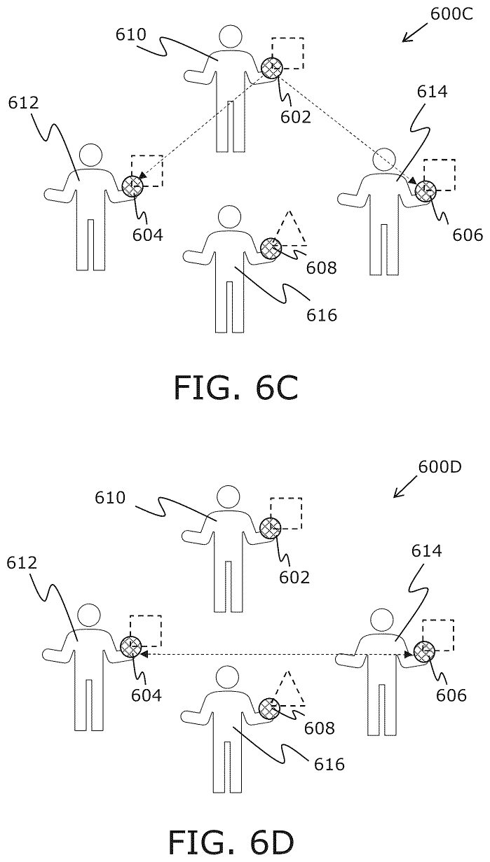

Referring to FIG. 6A, 6B, 6C and 6D, illustrate an environment 600A, 600B, 600C and 600D, wherein a system and a method for sharing data amongst handheld interaction devices 602, 604, 606, and 608 are being utilised, in accordance with an embodiment of the present disclosure. Herein, four persons 610, 612, 614, and 616 are holding four handheld interaction devices 602, 604, 606, and 608. A first person 610 is holding a first handheld interaction device 602, a second person 612 is holding a second handheld interaction device 604, a third person 614 is holding a third handheld interaction device 606, and a fourth person 616 is holding a fourth handheld interaction device 608.

In FIG. 6A, illustrated is an environment 600A wherein the four handheld interaction devices 602, 604, 606, and 608 being held by the four persons 610, 612, 614, and 616.

In FIGS. 6B, 6C and 6D, illustrated are environment 600B, 600C and 600D wherein the four persons 610, 612, 614, and 616 provide gestures via the four handheld interaction devices 602, 604, 606, and 608. Herein, the first person 610 holding the first handheld interaction device 602 provides a ‘square’ gesture, indicating that they may wish to share data. The second person 612 and the third person 616, correspondingly holding the second handheld interaction device 604 and the third handheld interaction device 606, provide a ‘square’ gesture in response to the gesture provided by the first person 610 to indicate that they may wish to receive the data. However, the fourth person 616 holding the fourth handheld interaction device 608 provides a ‘triangle’ gesture to indicate that they may not wish to receive the data.

In FIG. 6B, illustrated is the environment 600B wherein the four persons 610, 612, 614, and 616 provide gestures via the four handheld interaction devices 602, 604, 606, and 608.

In FIG. 6C, illustrated is the environment 600C wherein data is shared between the handheld interaction devices 602, 604 and 606. Herein, since the second person 612 and the third person 616, correspondingly holding the second handheld interaction device 604 and the third handheld interaction device 606, provide the ‘square’ gesture in response to the ‘square’ gesture provided by the first person 610 holding the first handheld interaction device 602, the data is shared to the second handheld interaction device 604 and the third handheld interaction device 606.

In FIG. 6D, illustrated is the environment 600D wherein data is shared between the handheld interaction devices 604 and 606. Herein, since the since the second person 612 and the third person 616, correspondingly holding the second handheld interaction device 604 and the third handheld interaction device 606, provide the ‘square’ gesture, the data may be shared between the second handheld interaction device 604 and the third handheld interaction device 606.

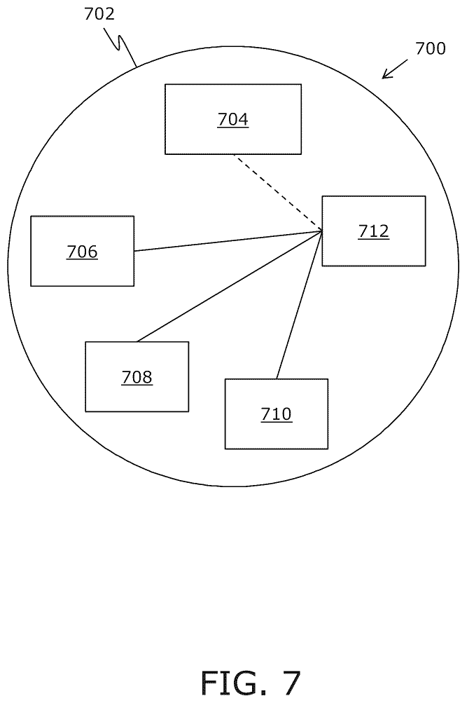

Referring to FIG. 7, illustrated is a handheld interaction device 700, in accordance with an embodiment of the present disclosure. The handheld interaction device 700 comprises a housing 702, a battery 704, a communication interface 706, at least one sensor (implemented as a sensor 708), at least one memory (implemented as a memory 710) and a processor 712. The housing 702 provides shape and structure to the handheld interaction device 700. The battery 704 is configured to power the handheld interaction device 700. The memory 710 is configured to store a data, a set of gesture inputs, a set of gesture codes, and information indicative of a linking of each gesture input in the set of gesture inputs to a corresponding gesture code in the set of gesture codes. The processor 712 is configured to execute a set of steps of a method for sharing data amongst handheld interaction devices. The processor 712 is coupled to the communication interface 706, the sensor 708, and the memory 710.

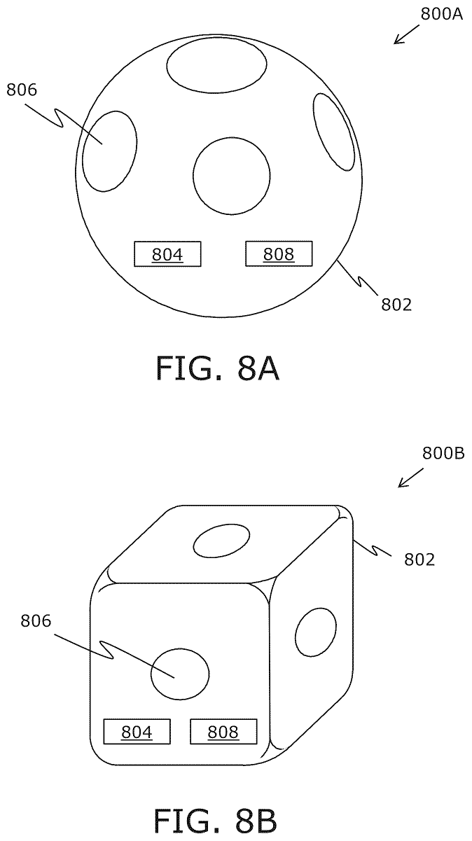

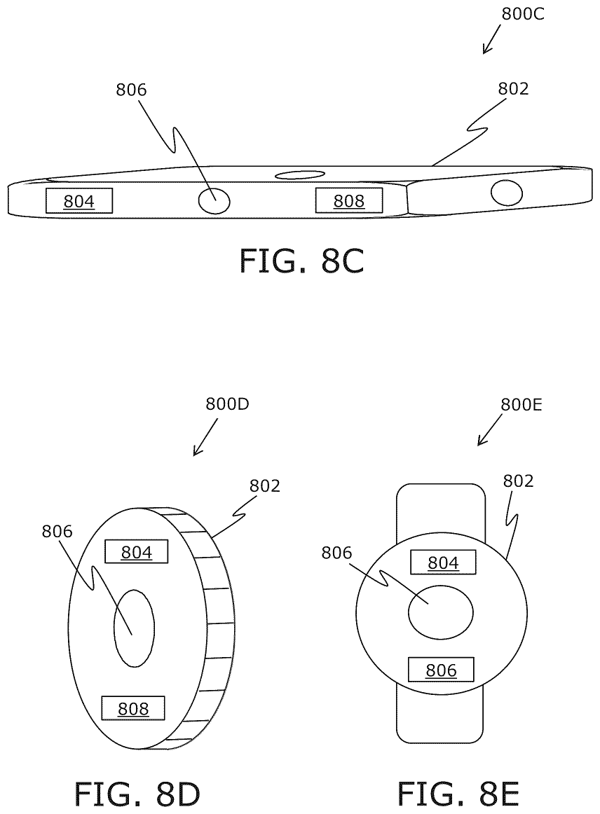

Referring to FIGS. 8A, 8B, 8C, 8D and 8E, illustrated is a handheld interaction device 800, in accordance with various embodiments of the present disclosure. The handheld interaction device 800 comprises a housing 802, a battery 804, at least one sensor (implemented as a sensor 806), and a processor 808. The housing 802 provides shape and structure to said handheld interaction device 800. The battery 804 is configured to power the handheld interaction device 800. The sensor 806 is implemented as at least one of: an accelerometer, a gyroscope, a magnetometer. Herein, the processor 808 is configured to process sensor data generated by the sensor 806 to detect a gesture input. In FIG. 8A, as shown, the handheld interaction device 800 is implemented as a ball-type device 800A. Herein, the handheld interaction device 800A has a spherical shape. In FIG. 8B, as shown, the handheld interaction device 800 is implemented as a dice-type device 800B. Herein, the handheld interaction device 800B has a cubical shape. In FIG. 8C, as shown, the handheld interaction device 800 is implemented as a bar-type device 800C. Herein, the handheld interaction device 800A has a cuboidal shape. In FIG. 8D, as shown, the handheld interaction device 800 is implemented as a coin-type device 800D. Herein, the handheld interaction device 800D has a cylindrical or a disk-like shape. In FIG. 8E, as shown, the handheld interaction device 800 is implemented as a wearable device 800A. Herein, the handheld interaction device 800A has been represented as a wristwatch.

It may be understood by a person skilled in the art that the FIGS. 4A, 4B, 4C, 4D, 5A, 5B, 6A, 6B, 6C, 6D, 7, 8A, 8B, 8C, 8D and 8E are merely examples for sake of clarity, which should not unduly limit the scope of the claims herein. The person skilled in the art will recognize many variations, alternatives, and modifications of embodiments of the present disclosure.

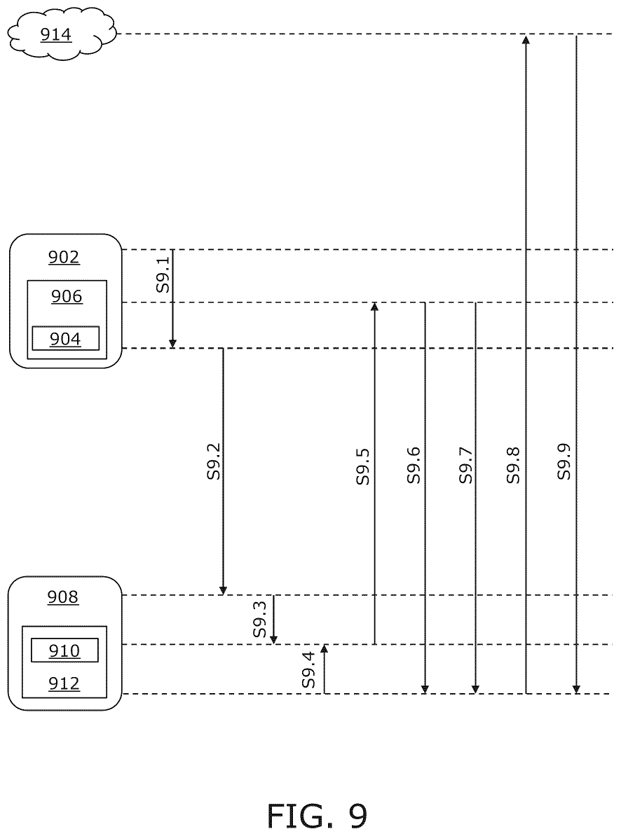

Referring to FIG. 9, illustrated is an exemplary process flow of a method for sharing data amongst handheld interaction devices using auxiliary data, in accordance with an embodiment of the present disclosure. At step S9.1, a first handheld interaction device 902 is used to provide a first gesture input. Herein, the first gesture input is stored in a gesture database 904 of a memory 906 of the first handheld interaction device 902. Moreover, the first gesture input is mapped to a first gesture code stored in the gesture database 904. At step S9.2, the first gesture code and a first auxiliary data is shared to a second handheld interaction device 908. Herein, the first auxiliary data is sent after the first gesture code. At step S9.3, the first gesture code is detected by the second handheld interaction device 908. At step S9.4, the second handheld interaction device 908 is used to provide a second gesture input. Herein, the second gesture input is stored in a gesture database 910 of a memory 912 of the second handheld interaction device. Moreover, the second gesture input is mapped to a second gesture code stored in the gesture database 910. Furthermore, the first gesture code is compared to a second gesture code to determine whether the first gesture code is equal to the second gesture code. At step S9.5, activating the second handheld interaction device 908 to receive a first data. When the first gesture code is equal to the second gesture code, at step S9.6, the first handheld interaction device 902 sends the first data to the second handheld interaction device 908. At step S9.7, the first handheld interaction device 902 sends information pertaining to the first data to the second handheld interaction device 908. When the first gesture code is not equal to the second gesture code, the first auxiliary data is utilised to map the first gesture code to a corresponding second gesture code and when the corresponding second gesture code is equal to the first gesture code, at step S9.8, the second handheld interaction device 908 sends a request to a cloud database 914 to receive the first data. At step S9.9, the cloud database 914 sends the first data to the second handheld interaction device 908.

The steps S9.1 to S9.9 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for sharing data amongst handheld interaction devices that are communicably coupled, the method comprising:
detecting a first gesture input that is provided using a first handheld interaction device, wherein the first gesture input is an activity related to sharing a first data from the first handheld interaction device to at least one second handheld interaction device;
mapping the first gesture input to a first gesture code from amongst a first set of gesture codes that are stored in the first handheld interaction device;
sharing at least the first gesture code to the at least one second handheld interaction device;
detecting at least one second gesture input that is provided using the at least one second handheld interaction device;
mapping the at least one second gesture input to at least one second gesture code from amongst at least one second set of gesture codes that are stored in the at least one second handheld interaction device;
comparing the first gesture code with the at least one second gesture code for determining whether a second gesture code amongst the at least one second gesture code is equal to the first gesture code;
when the second gesture code is equal to the first gesture code, activating a corresponding second handheld interaction device amongst the at least one second handheld interaction device for receiving the first data; and
sending the first data from the first handheld interaction device to the corresponding second handheld interaction device.

2. A method of claim 1, further comprising:
sharing at least the second gesture code to at least one third handheld interaction device;
detecting at least one third gesture input that is provided using the at least one third handheld interaction device;
mapping the at least one third gesture input to at least one third gesture code from amongst at least one third set of gesture codes that are stored in the at least one third handheld interaction device;
comparing the second gesture code with the at least one third gesture code for determining whether a third gesture code amongst the at least one third gesture code is equal to the second gesture code;
when the third gesture code is equal to the second gesture code, activating a corresponding third handheld interaction device amongst the at least one third handheld interaction device for receiving the first data; and
sending the first data from the corresponding second handheld interaction device to the corresponding third handheld interaction device.

3. A method of claim 1, further comprising:
detecting a set of gesture inputs provided using a handheld interaction device, wherein each gesture input in the set is one of: a predefined gesture input, a user-defined gesture input;
storing the set of gesture inputs and a set of gesture codes in the handheld interaction device;
linking each gesture input in the set of gesture inputs to a corresponding gesture code in the set of gesture codes; and
storing information indicative of said linking in the handheld interaction device.

4. A method of claim 1, further comprising:
activating a learning mode of a handheld interaction device for enabling the handheld interaction device to learn a user-defined gesture input;
recording a training gesture input that is provided repeatedly using the handheld interaction device during the learning mode, wherein a number of repetitions of the training gesture input is predefined;
determining a similarity score of the repetitions of the training gesture input; and
determining the user-defined gesture input to be the training gesture input, when the similarity score is equal to or greater than a similarity threshold.

5. A method of claim 1, wherein a gesture input is detected based on at least one of: a number of points in the gesture input, a relative location of a starting point and an ending point of the gesture input, a pattern of direction changes in the gesture input, a number of direction changes in the gesture input, an angle between two consecutive direction changes in the gesture input, a total revolution about a given point, a length of movement along a direction in the gesture input.

6. A method of claim 1, wherein the first data comprises information of a second data that is stored in an external device, the information includes at least a network address of the external device, wherein the method further comprises:
sending a command from the corresponding second handheld interaction device to the network address of the external device, wherein the command indicates readiness of the corresponding second handheld interaction device for receiving the second data; and
sending the second data from the external device to the corresponding second handheld interaction device, upon receiving the command at the external device.

7. A method of claim 1, further comprising confirming successful reception of the first data at the corresponding second handheld interaction device by controlling at least one interaction element for providing at least one indication, the at least one indication being at least one of: a visual indication, an audio indication, a vibration indication, some other physical indication.

8. A method of claim 1, wherein the step of sharing at least the first gesture code to the at least one second handheld interaction device comprises sharing also a first auxiliary data of the first data, along with the first gesture code, to the at least one second handheld interaction device.

9. A method of the claim 8, further comprising:
controlling a first interaction element of the first handheld interaction device to provide a first indication at least while sending the first data to the corresponding second handheld interaction device;
upon receiving the first data from the first handheld interaction device, authenticating the first data using the first auxiliary data;
upon successful authentication of the first data, controlling a second interaction element of the corresponding second handheld interaction device to provide a second indication, wherein the second indication is same as the first indication.

10. A method of claim 1, wherein the step of sending the first data from the first handheld interaction device to the corresponding second handheld interaction device comprises activating data transmission upon detecting an activation input that is provided to the first handheld interaction device and transferring the first data to the corresponding second handheld interaction device upon the activation of the data transmission.

11. A method according to claim 1, wherein the at least one second handheld interaction device is within a predefined distance from the first handheld interaction device.

12. A method of claim 11, wherein the predefined distance is related to at least one of: a size of a gesture input, a number of times the gesture input is provided in one instance.

13. A system for sharing data amongst handheld interaction devices that are communicably coupled, the system comprising:
a first processor of a first handheld interaction device; and
at least one second processor of at least one second handheld interaction device;
wherein the first processor is configured to:
detect a first gesture input that is provided using the first handheld interaction device, wherein the first gesture input is an activity related to sharing a first data from the first handheld interaction device to the at least one second handheld interaction device;
map the first gesture input to a first gesture code from amongst a first set of gesture codes that are stored in the first handheld interaction device; and
share at least the first gesture code to the at least one second handheld interaction device;
and wherein the at least one second processor is configured to:
detect at least one second gesture input that is provided using the at least one second handheld interaction device;
map the at least one second gesture input to at least one second gesture code from amongst the at least one second set of gesture codes that are stored in the at least one second handheld interaction device;
compare the first gesture code with the at least one second gesture code to determine whether a second gesture code amongst the at least one second gesture code is equal to the first gesture code;
when the second gesture code is equal to the first gesture code, activate a corresponding second handheld interaction device amongst the at least one second handheld interaction device for receiving the first data; and
receive the first data from the first handheld interaction device, the first data being sent by the first processor upon receiving the first command at the first handheld interaction device.

14. A system of claim 13, further comprising an external processor of an external device, the external device having a second data stored thereat, wherein the first data comprises information of the second data, the information including at least a network address of the external device, and wherein the external processor is configured to:
receive a command that is sent from the corresponding second handheld interaction device to the network address of the external device, wherein the command indicates readiness of the corresponding second handheld interaction device for receiving the second data; and
send the second data from the external device to the corresponding second handheld interaction device.

15. A handheld interaction device comprising:
a housing which provides shape and structure to said handheld interaction device;
a battery configured to power the handheld interaction device;
a communication interface;
at least one sensor;
at least one memory configured to store a data, a set of gesture inputs, a set of gesture codes, and information indicative of a linking of each gesture input in the set of gesture inputs to a corresponding gesture code in the set of gesture codes; and
a processor coupled to the communication interface, the at least one sensor, and the at least one memory, wherein the processor is configured to execute a set of steps of the method of any of claims 1.

16. A handheld interaction device of claim 15, wherein the at least one sensor is implemented as at least one of:
an accelerometer, a gyroscope, a magnetometer, and wherein the processor is configured to process sensor data generated by the at least one sensor to detect a gesture input.

17. A handheld interaction device of claim 15, wherein the handheld interaction device is used by a user for at least one of: an indoor activity, an outdoor activity, and wherein a given activity pertains to at least one of: gaming, entertainment, education, software development and testing, simulation.

18. A handheld interaction device of any of claims 15, wherein the handheld interaction device is implemented as one of: a ball-type device, a dice-type device, a bar-type device, a coin-type device, a wearable device, any other type of device.
